(19) United States
(12) Patent Application Publication
(10) Pub. No.: US 2023/0342522 A1
(43) Pub. Date: Oct. 26, 2023

(54) A DIGITAL TWIN FRAMEWORK OF WELD JOINT FATIGUE BASED ON STRUCTURAL STRESS METHOD

(71) Applicant: DALIAN UNIVERSITY OF TECHNOLOGY, Dalian, Liaoning (CN)

(72) Inventors: Xueguan SONG, Dalian, Liaoning (CN); Xiwang HE, Dalian, Liaoning (CN); Kunpeng LI, Dalian, Liaoning (CN); Xiaonan LAI, Dalian, Liaoning (CN); Liangliang YANG, Dalian, Liaoning (CN); Yitang WANG, Dalian, Liaoning (CN); Wei SUN, Dalian, Liaoning (CN)

(21) Appl. No.: 17/799,474

(22) PCT Filed: May 5, 2022
(86) PCT No.: PCT/CN2022/090893

§ 371 Date: Aug. 12, 2022

(30) Foreign Application Priority Data
Sep. 27, 2021 (CN) 202111134347.1

(51) Int. Cl. G06F 30/23

(52) U.S. Cl. CPC G06F 30/23

(57) ABSTRACT

The present invention belongs to the field of the digital twin, and relates to a digital twin framework of weld joint fatigue based on a structural stress method. The framework is divided into an off-line stage and an on-line stage, wherein the off-line stage comprises establishing a finite element model, calculating equivalent structural stress, and training an artificial intelligence algorithm; and the on-line stage comprises reading sensor data, predicted by the artificial intelligence algorithm, counting by a rainflow counting method and calculating remaining life by cumulative damage. The framework combines five methods, i.e. a finite element method, a structural stress method, the artificial intelligence algorithm, an upper envelope method, the rainflow counting method, and a Miner linear cumulative damage method. The present invention realizes visual feedback and early warning of a dangerous position of a weld joint through real-time prediction of mechanical properties and fatigue damage of the weld joint.

### TECHNICAL FIELD

The present invention relates to a digital twin framework of weld joint fatigue based on a structural stress method and belongs to the field of the digital twin.

### BACKGROUND

Welding connection is a widespread structural connection manner in the industrial field, which plays a very important role in structural design. Therefore both structural strength and fatigue strength of welding are very important. Generally, the yield strength and tensile strength of a flat welded steel structure are not lower than those of base metal, but the fatigue strength of a weld joint is far lower than that of the base metal. A primary form of weld joint failure is fatigue, and therefore fatigue strength analysis of the weld joint is very important.

With the development of automation technologies and computer science, a digital twin technology, which presents a physical entity in the real world in a virtual digital form, appears in people's vision. The digital twin technology uses data such as a physical model, sensor update, and operation history of a piece of real equipment to integrate a multi-disciplinary, multi-scale, and multi-physics simulation process, set up a digital twin faithfully mapping the real equipment, provide guidance for operating condition monitoring, repair and maintenance, and failure warning of the equipment in a whole life cycle of the equipment. Therefore, in order to avoid the occurrence of safety accidents, perceive the properties and conditions of the weld joint in advance, thus to predict the fatigue state of the weld joint, and give certain guidance to working staff, it is urgent to develop a weld joint fatigue digital twin framework based on a structural stress method. However, no such digital twin framework is available on market at present. Especially, it is urgent to realize real-time fatigue monitoring of a fatigue condition of the weld joint.

### SUMMARY

The purpose of the present invention is to provide a weld joint fatigue digital twin framework based on a structural stress method, an artificial intelligence algorithm, a rainflow counting method, and a cumulative fatigue damage method, which realizes visual feedback and early warning of a dangerous position of a weld joint through real-time prediction of mechanical properties and fatigue damage of the weld joint.

The technical difficulties to be solved in the present invention include:
(1) How to calculate internal structural stress of the weld joint in different states, ensure accuracy and validity of fatigue data, and thus achieve accuracy and validity of a digital twin model.
(2) How to realize online prediction of a weld joint fatigue digital twin in different states based on the artificial intelligence algorithm, and thus ensure the perception of the operating state of equipment in advance.
(3) How to obtain the remaining useful life condition of a structure based on input and output relationships of sensor data—internal structural properties—remaining life through a small amount of sensor data during the operation of the equipment.

To solve the above problems, the present invention is realized by the following technical solution:

A digital twin framework of weld joint fatigue based on a structural stress method. The framework is divided into an off-line stage and an on-line stage, wherein the off-line stage comprises establishing a finite element model, calculating equivalent structural stress, and training an artificial intelligence algorithm; and the on-line stage comprises reading sensor data, predicted by the artificial intelligence algorithm, counting by a rainflow counting method and calculating remaining life by cumulative damage. The framework combines five methods, i.e. a finite element method, a structural stress method, the artificial intelligence algorithm, an upper envelope method, the rainflow counting method, and a Miner linear cumulative damage method. The details are as follows:

### Off-Line Stage:

(1) Establishing a three-dimensional model of a weld joint and dividing meshes to obtain stiffness matrix information of units and nodes; introducing a displacement constraint condition solving formula as shown in formula (1) to obtain a global displacement solution of the model; extracting a nodal displacement on a unit from a global displacement according to numbering information of the units and the nodes; converting the nodal displacement into a local coordinate system of the unit, and then multiplying by a stiffness matrix of the unit to obtain all nodal forces and nodal moments of the unit.

$$( {\sum }_{l}^{m} k ) D = KD = F \qquad ( 1 )$$

Wherein: k is the stiffness matrix of the unit; K is a global stiffness matrix, and is formed by cumulating each unit based on the numbering information of the units and the nodes; D is a displacement vector; and F is a force vector.
(2) Converting the nodal forces into membrane stresses and converting the nodal moments into bending stresses based on information about the nodal forces and the nodal moments of the three-dimensional model of the weld joint. Summing the membrane stresses and the bending stresses to obtain structural stress data, as shown in formula (2).

$${σ}_{n} = {σ}_{m} + {σ}_{n} = \frac{1}{t} {L}^{- 1} ( {F}_{yn} + \frac{6}{t} {M}_{xn} ) \qquad ( 2 )$$

Wherein F_{yn} is a nodal force at a node; Mₓₙ is a nodal moment at the node; and t is a normal thickness of a desired weld joint. L is only related to distances between nodes and is defined as an equivalent matrix of a unit length, which can be expressed as:

$$L = [ \begin{matrix}\frac{{l}_{1}}{3} & \frac{{l}_{1}}{6} & 0 & ⋯ & 0 \\ \frac{{l}_{1}}{6} & \frac{( {l}_{1} + {l}_{2} )}{3} & \frac{{l}_{2}}{6} & ⋱ & 0 \\ 0 & ⋱ & ⋱ & ⋱ & ⋮ \\ ⋮ & ⋱ & ⋱ & \frac{( {l}_{n - 2} + {l}_{n - 1} )}{3} & \frac{{l}_{n - 1}}{6} \\ 0 & ⋯ & ⋯ & \frac{{l}_{n - 1}}{6} & \frac{{l}_{n - 1}}{3}\end{matrix} ] \qquad ( 3 )$$

Wherein lₗ, . . . , lₙ₋₁ respectively represent the distances between nodes from node 1 to nodeⁿ.
(3) In order to make structural stress at each node change continuously, obtaining structural stresses at the weld joint in several working conditions, and then training the obtained data by an artificial intelligence algorithm, thus obtaining a prediction model of the membrane stresses and the bending stresses of the weld joint. Take a Gaussian process (GP) as an example to detail a construction process of an artificial intelligence model. GP is a random process, and is specified by mean and covariance functions thereof; GP has advantages in handling high and nonlinear data and supports a predicted confidence interval. A Gaussian process is completely specified by a mean function and a covariance function thereof, i.e.:

$$\{ \begin{matrix}m ( x ) = E [ f ( x ) ] \\ k ( x , {x}^{′} ) = E [ ( f ( x ) - m ( x ) ) ( f ( {x}^{′} - m ( {x}^{′} ) ) ) ]\end{matrix} \qquad ( 4 )$$

Wherein m(x) is the mean function, k(x,x′) is the covariance function that follows a Gaussian distribution function value f , and a formula can be expressed as f˜GP(m(x),k(x,x′)) . A Gaussian process regression model can be given by the following formula:

y(X)=f(X)+ε (5)
Wherein x is an input vector, and f(·)and y(·)respectively represent a potential function and an output function. εis subject to an independent noise and can be expressed as a Gaussian distribution ε˜N(0, σₙₒᵢₛₑ²). Considering n data pairs S={(Xᵢ,yᵢ)}ᵢ₌₁ⁿ, wherein Xᵢ∈R^{d}, yᵢ∈R,i=1, . . . , n ,then n observation values Y={yᵢ, . . . , yₙ} are:

Y˜N(m(x), K_{X}+T) (6)
Wherein m(x) is the mean function, K_{X} and T are respectively a covariance matrix and noise data of input data. Then a joint distribution of a target value y and a function value f_{*} obtained according to prior prediction are:

$$[ \begin{matrix}Y \\ {f}_{*}\end{matrix} ] ∼ N ( [ \begin{matrix}m ( X ) \\ m ( {X}_{*} )\end{matrix} ] , [ \begin{matrix}{K}_{XX} + T & {K}_{{XX}_{*}} \\ {K}_{{X}_{*} X} & {K}_{{X}_{*} {X}_{*}}\end{matrix} ] ) \qquad ( 7 )$$

Wherein K_{XX}_{_{*}}=Kₙ=(kᵢⱼ) is an N×N covariance matrix evaluated for all input values X and prediction points X_{*}, and m(X) represents a mean value of x . A key prediction equation for Gaussian process regression can be expressed as:

f_{*}|X_{*},X,Y˜N(f̅_{*}, cov(f̅_{*})) (8)
Wherein f̅_{*}and cov(f̅_{*}) respectively represent a mean value and a variance of the predicted value f_{*}.

Constructing an artificial intelligence model of the membrane stresses and the bending stresses of the weld joint based on the trained data and an algorithm flow:

σₘ=f₁(T₁, . . . , T_{z})+ε₁

σ_{b}=f₂(T₁, . . . , T_{z})+ε₂

σₙ=f₃(T₁, . . . , T_{z})+ε₃ (9)

Wherein σₘ is a membrane stress, σ_{b} is a bending stress, σₙ is the structural stress, f₁, f₂ and f₃ are relationships of constructed sensing data with the membrane stress, the bending stress and the structural stress, and T₁, . . . T_{z} are data variables of a sensor.

### On-Line Stage:

First, reading measurement data of the sensor, and inputting the measurement data into a trained artificial intelligence model as shown in formula (9) to obtain changes in the membrane stress, the bending stress, and the structural stress with the sensing data in a single cycle.

Then, counting the obtained data of the membrane stress, the bending stress, and the structural stress based on a rainflow counting method, and the steps are as follows:
(1) In order to shorten data counting time, first connecting the read data from end to end to become fully closed data requiring only one rainflow count;
(2) Extracting a structural stress cycle by a four peak-valley technical principle, and recording a changing range; the criteria are as follows:

x₁≤x₃ and _{▴}x₂≤x₃

x₁≥x₃ and _{▴}x₂≥x₃ (10)
If one of the above two conditions is satisfied, a cycle Δxⱼ=|xᵢ₊₁−xᵢ| can be extracted; at the same time, points xᵢ₊₁ and xᵢ in an original stress-time history are deleted, and characteristic data thereof are recorded:
(3) Finding a maximum value and a minimum value of the changing range in the structural stress cycle, dividing corresponding intervals equidistantly there between according to a given series, and counting cycles thereof according to the intervals. Obtaining changing ranges of the membrane stress and the bending stress in the k^{th} cycle counted based on the rainflow counting method, as shown in formula (5), and a cycle number nₖ corresponding to the structural stress.

Δσ_{m,k}^{e}=^{max}σ_{m,k}^{e}−^{min}σ_{m,k}^{e}

Δσ_{b,k}^{e}=^{max}σ_{b,k}^{e}−^{min}σ_{b,k}^{e} (11)
Wherein Δσ_{m,k}^{e} represents the changing range of the membrane stress, and Δσ_{b,k}^{e} represents the changing range of the bending stress; and constructing an upper envelope model along the weld joint by extracting the data of the changing range to obtain corrected membrane stresses and bending stresses, i.e. making stress changing trends on the weld joint similar, so as to avoid an inconsistent changing rule of the weld joint on a structure caused by the artificial intelligence algorithm.
(4) Calculating the changing range of an equivalent structural stress in the k^{th} cycle according to the membrane stresses and the bending stresses:

$$Δ {S}_{ess , k} = \frac{Δ {σ}_{m , k}^{e} - Δ {σ}_{b , k}^{e}}{{t}^{( 2 - m ) / 2 m} {I ( r )}^{- 1 / m}} \qquad ( 12 )$$

Wherein t is the normal thickness of the desired weld joint, m=3.6 is a design constant, and I(r) is a dimensionless function of a bending load ratio r and can be recorded as:

$${I ( r )}^{\frac{1}{m}} = 2.1549 {r}^{6} - 5.0422 {r}^{5} + 4.8002 {r}^{4} - 2.0694 {r}^{3} + 0.561 {r}^{2} + 0.0097 r + 1.5426 \qquad ( 13 )$$

r is the bending load ratio and is recorded as:

$$r = \frac{\vert Δ {σ}_{b , k} \vert}{\vert Δ {σ}_{m , k} \vert + \vert Δ {σ}_{b , k} \vert} \qquad ( 14 )$$

(5) Calculating the changing range of the equivalent structural stress and the bending load ratio in a cycle based on main S-N curve data obtained from a weld fatigue test, thus to obtain number of fatigue cycles under the equivalent structural stress.

Nₖ=(ΔS_{ess,k}|Cd)^{-1/h} (15)
Wherein Nₖ is a maximum number of cycles corresponding to the equivalent structural stress, Cd is a statistical constant of the test, the median is Cd=19930.2 , and h=0.3195.
(6) Calculating remaining fatigue life by a Miner linear damage cumulative method based on the counted number of cycles corresponding to the equivalent structural stress.

$${D}_{f} = 1 - {\sum }_{k = 1}^{m} \frac{{n}_{k}}{{N}_{k}} \qquad ( 16 )$$

In the whole digital twin framework, the rainflow counting method mainly plays a function of counting cycles. During the operation of the equipment, because the operating condition is changing, a cycle counting method is needed to realize monitoring of operation cycles. If D_{f}<0, a calculated weld joint model fails.

To sum up, the present invention has the following beneficial effects:
(1) The present invention realizes real-time monitoring of weld joint fatigue in the operating state of the structure, so as to realize early warning of the operating state of the equipment, guarantee personal safety and improve enterprise benefits.
(2) The present invention can be used to observe the fatigue condition of the structure in the operating state, so as to promote an in-depth understanding of the operator of the equipment and improve man-machine interaction ability.
(3) The present invention realizes virtual-real interaction of the equipment by combining a physical model and a virtual model of the machine and equipment based on a small amount of sensing information, so as to observe information data that cannot be seen by the equipment and improve the credibility of calculation results.

### DESCRIPTION OF DRAWINGS

FIG. 1 is a schematic diagram for realizing the technical process of the present invention;

FIG. 2 is a schematic diagram of the technical architecture of the present invention;

FIG. 3 is a schematic diagram of a weld joint structure of the present invention;

FIG. 4 is a schematic diagram of a four peak-valley technical principle adopted in the present invention;

FIG. 5(a) and FIG. 5(b) show the comparison of equivalent structural stress before and after calculation by an upper envelope model; and

FIG. 6 is a schematic diagram of the number of fatigue cycles obtained in an operating condition of a tractor.

In the figures: 1 base metal part of the structure, 2 welds joint part of the structure, 3 weld line of weld joint structure, 4 tractor, and 5 crane main beam.

### DETAILED DESCRIPTION

The technical solution of the present invention is further described below in detail in combination with the drawings and the specific embodiment which is described to only explain the present invention but not to limit the present invention.

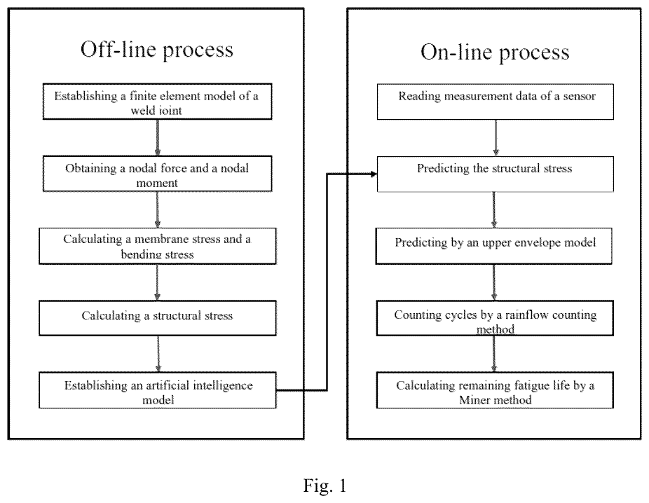

FIG. 1 is a schematic diagram for realizing a technical process of a weld joint fatigue twin set up by the present invention. The twin can be divided into an off-line stage and an on-line stage. In the off-line stage, first, a finite element model is established and solved by defining a unit type, material, boundary condition, etc. of a weld joint structure. Then, nodal forces and nodal moments on a weld line are calculated based on a nodal displacement and a stiffness matrix of a unit obtained. Finally, membrane stress and bending stress on the weld line are calculated by a structural stress method based on the data of the nodal forces and the nodal moments, and the membrane stress and the bending stress are summed to obtain structural stress. In order to predict a fatigued state of the weld joint structure in different operating conditions, it is necessary to build an artificial intelligence model driven by data, and then calculate the structural stress on the weld line in real-time in combination with sensing data of a sensor. In the on-line stage, it is mainly to realize real-time prediction of the membrane stress, the bending stress, and the structural stress by reading sensor data and inputting the data into the artificial intelligence model, calculating changing range of the data in a cycle and number of cycles experienced by counting cycles of the predicted data by a rainflow counting method and calculate remaining fatigue life according to the counted data by a Miner cumulative fatigue damage method.

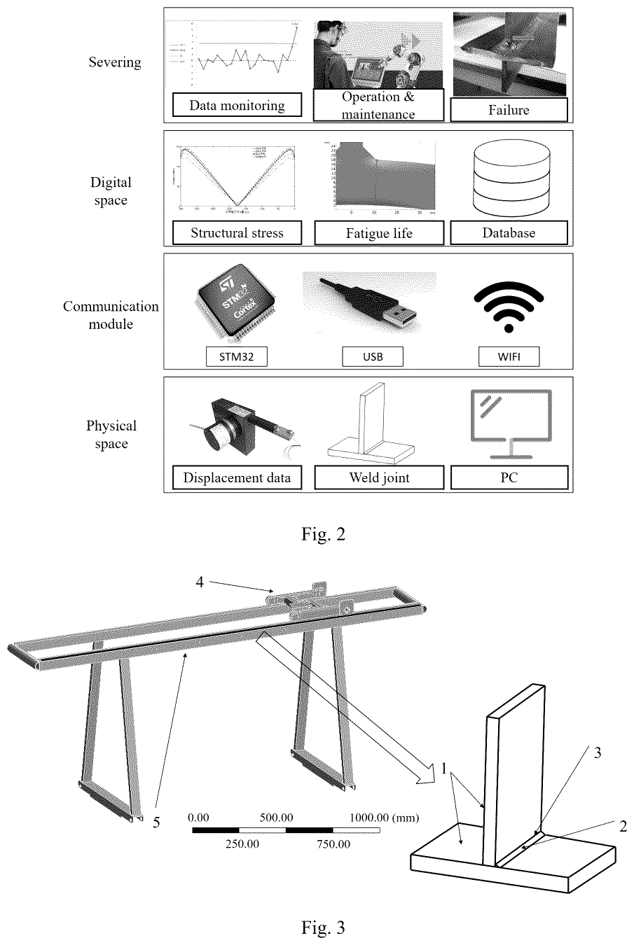

FIG. 2 shows the technical architecture of the present invention. In a specific application, the present invention can be divided into four parts, i.e. a physical space, a communication module, a digital space, and a serving end, which are connected through a data drive and are inseparable. The physical space is mainly composed of sensor equipment, a weld joint structure, a personal computer, and the like; the communication module is composed of a variety of data protocols and technologies such as WIFI, USB, and Fieldbus, and is used to ensure accuracy, timeliness, and readability of a data transmission process; the digital space comprises functions of structural stress analysis, fatigue data storage and so on, which can realize data storage and weld joint model analysis; and the serving end is a final place to stay of a digital twin set up, which may usually comprise functions of fatigue failure early warning, structural stress data monitoring, equipment operation & maintenance management, etc.

The detailed description of the present invention will be further made below through an embodiment. Specifically, the description is made by taking the establishment of a fatigue digital twin for a certain weld joint as an example.

Taking a certain weld joint structure as a research object and referring to FIG. 3, the figure contains a base metal part of structure 1, a weld joint part of structure 2, a weld line of weld joint structure 3, a running tractor 4, and a crane main beam 5. Welding connection at a running tractor track of the structure is realized by the weld joint, the running tractor 4 is on an upper end of the track, and a running distance of the tractor is mainly obtained by a sensor. A finite element model of the structure in an operating condition of the tractor 4 is established and solved, and data of nodal forces and nodal moments are derived. Membrane stress, bending stress, and structural stress of the structure are calculated based on formulas (2-3) and input into an artificial intelligence algorithm as training data, as shown in formulas (4-8), to construct an artificial intelligence model. By reading the data of the running distance of the tractor, a current operating state of the structure can be judged; and by reading real-time sensing data into the artificial intelligence model as shown in formula (9), the membrane stress, the bending stress and the structural stress of the model can be calculated in real-time.

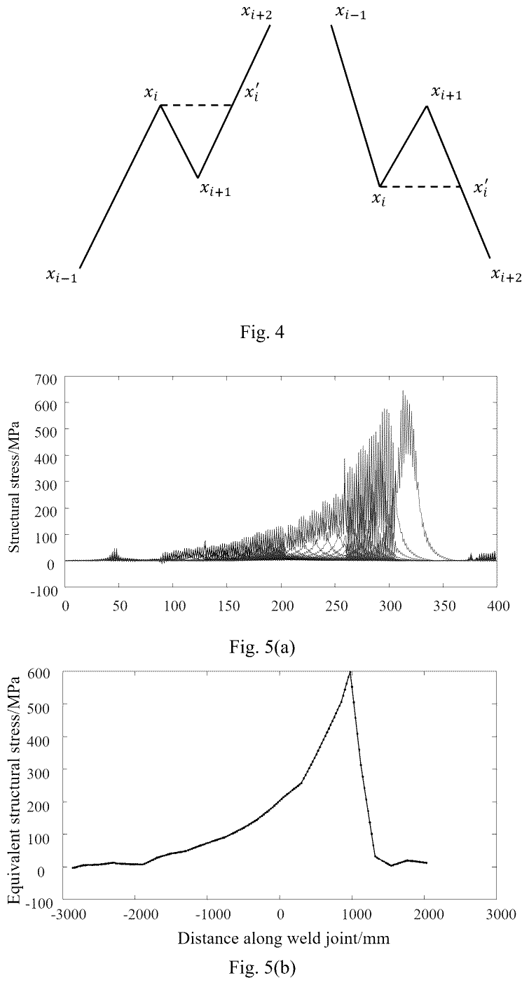

Referring to FIG. 4, the figure shows a four-peak-valley counting principle in a rainflow counting method. Changing ranges and cycles of the membrane stress, the bending stress, and the structural stress in a time series are counted by the rainflow counting method, as shown in formulas (11-14). Two criteria are mainly adopted by the rainflow counting method, as shown in formula (10). If the above two conditions are satisfied, a cycle Δxⱼ=|xᵢ₊₁−xᵢ| (a part forming a triangle in the figure) can be extracted, a changing range thereof can be recorded, and at the same time, xᵢ₊₁ and xᵢ can be deleted. If the length of a whole data history is less than 3, it means that all cycles of rainflow counting are extracted.

Referring to FIG. 5(a) and FIG. 5(b), the figures show the comparison of equivalent structural stress before and after calculation by an upper envelope model. First, an upper envelope model is constructed along the weld joint, i.e. stress changing trends on the weld joint are made similar, so as to avoid an inconsistent changing rule of the weld joint on the structure caused by the artificial intelligence algorithm. Uncorrected structural stress of the upper envelope model has large stress changing trend and therefore will cause inaccurate results.

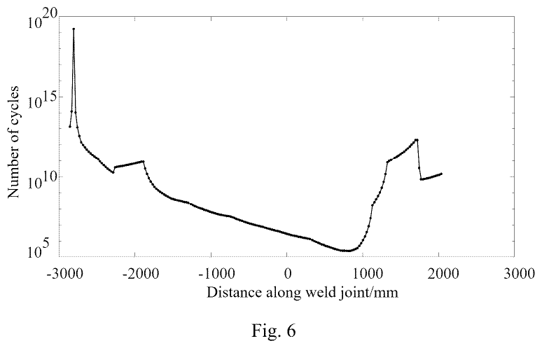

Referring to FIG. 6, the figure shows the number of fatigue cycles in the operating condition, as shown in formula (15). It can be found that the number of fatigue cycles in an area with larger structural stress in a weld joint area is small, the number of cycles calculated by the method is changed evenly, and the method has high credibility. Finally, the remaining useful life of the weld joint structure can be obtained based on formula (16) by extracting the data in all cycles.

1. A digital twin framework of weld joint fatigue based on a structural stress method, wherein the framework is divided into an off-line stage and an on-line stage, which is specifically as follows:
off-line stage:
(1) establishing a three-dimensional model of a weld joint and dividing meshes to obtain stiffness matrix information of units and nodes; introducing a displacement constraint condition solving formula as shown in formula (1) to obtain a global displacement solution of the model; extracting a nodal displacement on a unit from a global displacement according to numbering information of the units and the nodes; converting the nodal displacement into a local coordinate system of the unit, and then multiplying by a stiffness matrix of the unit to obtain all nodal forces and nodal moments of the unit;
$$( {\sum }_{l}^{m} k ) D = KD = F \qquad ( 1 )$$
wherein: k is the stiffness matrix of the unit; K is a global stiffness matrix, and is formed by cumulating each unit based on the numbering information of the units and the nodes; D is a displacement vector; and F is a force vector;
(2) converting the nodal forces into membrane stresses and converting the nodal moments into bending stresses based on information about the nodal forces and the nodal moments of the three-dimensional model of the weld joint; summing the membrane stresses and the bending stresses to obtain structural stress data, as shown in formula (2);
$${σ}_{n} = {σ}_{m} + {σ}_{n} = \frac{1}{t} {L}^{- 1} ( {F}_{yn} + \frac{6}{t} {M}_{xn} ) \qquad ( 2 )$$
wherein F_{yn} is a nodal force at a node; Mₓₙ is a nodal moment at the node; t is a normal thickness of a desired weld joint; L is only related to distances between nodes and is defined as an equivalent matrix of a unit length, which is expressed as:
$$L = [ \begin{matrix}\frac{{l}_{1}}{3} & \frac{{l}_{1}}{6} & 0 & … & 0 \\ \frac{{l}_{1}}{6} & \frac{( {l}_{1} + {l}_{2} )}{3} & \frac{{l}_{2}}{6} & ⋱ & 0 \\ 0 & ⋱ & ⋱ & ⋱ & ⋮ \\ ⋮ & ⋱ & ⋱ & \frac{( {l}_{n - 2} + {l}_{n - 1} )}{3} & \frac{{l}_{n - 1}}{6} \\ 0 & … & … & \frac{{l}_{n - 1}}{6} & \frac{{l}_{n - 1}}{3}\end{matrix} ] \qquad ( 3 )$$
wherein l₁, . . . , lₙ₋₁ respectively represent the distances between nodes from node 1 to nodeⁿ.
(3) in order to make structural stress at each node change continuously, obtaining structural stresses at the weld joint in several working conditions, and then training the obtained data by an artificial intelligence algorithm, thus obtaining a prediction model of the membrane stresses and the bending stresses of the weld joint;
constructing an artificial intelligence model of the membrane stresses and the bending stresses of the weld joint based on the trained data and an algorithm flow:
σₘ−f₁(T₁, . . . , T_{z})+ε₁
σₕ=f₂(T₁, . . . , T_{z})+ε₂
σₙ=f₃(T₁, . . . , T_{z})+ε₃ (9)
wherein σₘ is a membrane stress, σ_{b} is a bending stress, σₙ is the structural stress, f₁, f₂ and f₃ are relationships of constructed sensing data with the membrane stress, the bending stress and the structural stress, and T₁, . . . , T_{z} are data variables of a sensor;
On-Line Stage:
first, reading measurement data of the sensor, and inputting the measurement data into a trained artificial intelligence model as shown in formula (9) to obtain changes of the membrane stress, the bending stress and the structural stress with the sensing data in a single cycle;
then, counting the obtained data of the membrane stress, the bending stress and the structural stress based on a rainflow counting method, and the steps are as follows:
(1) in order to shorten data counting time, first connecting the read data from end to end to become fully closed data requiring only one rainflow count;
(2) extracting a structural stress cycle by a four peak-valley technical principle, and recording a changing range; criteria are as follows:
x₁≤x₃ and _{▴}x₂≤x₃
x₁≥x₃ and _{▴}x₂≥x₃ (10)
if one of the above two conditions is satisfied, a cycle Δxⱼ=|xᵢ₊₁−xᵢ| can be extracted; at the same time, points xᵢ₊₁ and xᵢ in an original stress-time history are deleted, and characteristic data thereof are recorded:
(3) finding a maximum value and a minimum value of the changing range in the structural stress cycle and dividing corresponding intervals equidistantly therebetween according to a given series, and counting cycles thereof according to the intervals; obtaining changing ranges of the membrane stress and the bending stress in the k^{th} cycle counted based on the rainflow counting method, as shown in formula (5), and a cycle number nₖ corresponding to the structural stress;
Δσ_{m,k}=^{max}σ_{m,k}^{e}−^{min}σ_{m,k}^{e}
Δσ_{b,k}^{e}=^{max}σ_{b,k}^{e}−^{min}σ_{b,k}^{e} (11)
wherein Δσ_{m,k}^{e} represents the changing range of the membrane stress, and Δσ_{b,k}^{e} represents the changing range of the bending stress; and constructing an upper envelope model along the weld joint by extracting the data of the changing range to obtain corrected membrane stresses and bending stresses, i.e. making stress changing trends on the weld joint similar, so as to avoid an inconsistent changing rule of the weld joint on a structure caused by the artificial intelligence algorithm;
(4) calculating the changing range of an equivalent structural stress in the k^{th} cycle according to the membrane stresses and the bending stresses:
$$Δ {S}_{ess , k} = \frac{Δ {σ}_{m , k}^{e} - Δ {σ}_{b , k}^{e}}{{t}^{( 2 - m ) / 2 m} {I ( r )}^{- 1 / m}} \qquad ( 12 )$$
wherein t is the normal thickness of the desired weld joint, m=3.6 is a design constant, and I(r) is a dimensionless function of a bending load ratio r and is recorded as:
$${I ( r )}^{\frac{1}{m}} = 2.1549 {r}^{6} - 5.0422 {r}^{5} + 4.8002 {r}^{4} - 2.0694 {r}^{3} + 0.561 {r}^{2} + 0.0097 r + 1.5426 \qquad ( 13 )$$
r is the bending load ratio and is recorded as:
$$r = \frac{\vert Δ {σ}_{b , k} \vert}{\vert Δ {σ}_{m , k} \vert + \vert Δ {σ}_{b , k} \vert} \qquad ( 14 )$$
(5) calculating the changing range of the equivalent structural stress and the bending load ratio in a cycle based on main S-N curve data obtained from a weld fatigue test, thus obtaining number of fatigue cycles under the equivalent structural stress;
Nₖ=(ΔS_{ess,k}|Cd)^{-1/h} (15)
wherein Nₖ is a maximum number of cycles corresponding to the equivalent structural stress, Cd is a statistical constant of the test, the median is Cd=19930.2, and h=0.3195;
(6) calculating remaining fatigue life by a Miner linear damage cumulative method based on the counted number of cycles corresponding to the equivalent structural stress;
$${D}_{f} = 1 - {\sum }_{k = 1}^{m} \frac{{n}_{k}}{{N}_{k}} . \qquad ( 16 )$$

2. The weld joint fatigue digital twin framework based on a structural stress method according to claim 1, wherein a Gaussian process is used to construct the artificial intelligence model, and the process is as follows;
a Gaussian process is completely specified by a mean function and a covariance function thereof, i.e.:
$$\{ \begin{matrix}m ( x ) = E [ f ( x ) ] \\ k ( x , {x}^{′} ) = E [ ( f ( x ) - m ( x ) ) ( f ( {x}^{′} - m ( {x}^{′} ) ) ) ]\end{matrix} \qquad ( 4 )$$
wherein m(x) is the mean function, k(x,x′) is the covariance function that follows a Gaussian distribution function value f , and a formula is expressed as f˜GP(m(x),k(x,x′)) ; and a Gaussian process regression model is given by the following formula:
y(X)=f(X)+ε (5)
wherein X is an input vector, and f(·) and y(·) respectively represent a potential function and an output function; ε is subject to an independent noise and is expressed as a Gaussian distribution ε˜N (0,σₙₒᵢₛₑ²) ; considering n data pairs S={(Xᵢ, yᵢ)}ᵢ₌₁ⁿ wherein Xᵢ∈R^{d}, yᵢ∈R,i=1, . . . , n, then n observation values Y={y₁, . . . , yₙ} are:
Y˜N(m(x),Kₓ+T) (6)
wherein m(x) is the mean function, Kₓ and T are respectively a covariance matrix and noise data of input data; then a joint distribution of a target value Y and a function value f_{*} obtained according to prior prediction are:
$$[ \begin{matrix}Y \\ {f}_{*}\end{matrix} ] ∼ N ( [ \begin{matrix}m ( X ) \\ m ( {X}_{*} )\end{matrix} ] , [ \begin{matrix}{K}_{XX} + T & {K}_{{XX}_{*}} \\ {K}_{{X}_{*} X} & {K}_{{X}_{*} {X}_{*}}\end{matrix} ] ) \qquad ( 7 )$$
wherein K_{XX}_{_{*}}=Kₙ=(kᵢⱼ) is an N×N covariance matrix evaluated for all input values X and prediction points X_{*}, and m(X) represents a mean value of X; a key prediction equation for Gaussian process regression is expressed as:
f_{*}|X_{*},X,Y˜N(f̅_{*},cov(f̅_{*})) (8)
wherein f̅_{*} and cov(f̅_{*}) respectively represent a mean value and a variance of the predicted value f_{*}.
